(19) United States
(12) Patent Application Publication
(10) Pub. No.: US 2023/0379404 A1
(43) Pub. Date: Nov. 23, 2023

(54) TERMINAL DEVICE, APPARATUS MANAGEMENT SERVER, INFORMATION PROCESSING SYSTEM, INFORMATION PROCESSING METHOD, AND MEDIUM

(71) Applicant: Mitsubishi Electric Corporation, Tokyo (JP)

(72) Inventors: Daisuke NAKAMURA, Tokyo (JP); Hiroaki SUGIURA, Tokyo (JP)

(73) Assignee: Mitsubishi Electric Corporation, Tokyo (JP)

(21) Appl. No.: 18/358,963

(22) Filed: Jul. 26, 2023

Related U.S. Application Data
(63) Continuation of application No. PCT/JP2021/004483, filed on Feb. 8, 2021.

(51) Int. Cl. H04L 67/75; G06F 3/14; G16Y 20/20; G16Y 40/35; G16Y 10/75

(52) U.S. Cl. CPC H04L 67/75; G06F 3/14; G16Y 20/20; G16Y 40/35; G16Y 10/75

(57) ABSTRACT

A terminal device is configured to include: an apparatus information acquiring unit that acquires apparatus information indicating a registered apparatus; an identification information acquiring unit that acquires identification information indicating whether the apparatus is an IoT apparatus or a non-IoT apparatus from an apparatus management server by transmitting the apparatus information acquired by the apparatus information acquiring unit to the apparatus management server; and a display data generating unit that generates display data indicating whether the apparatus is an IoT apparatus or a non-IoT apparatus on the basis of the identification information acquired by the identification information acquiring unit, and outputs the display data.

### CROSS-REFERENCE TO RELATED APPLICATION

The present application is a bypass-continuation of International Patent Application No. PCT/JP2021/004483, filed Feb. 8, 2021, the entire contents of which are incorporated herein by reference.

### TECHNICAL FIELD

The present disclosure relates to a terminal device, an apparatus management server, an information processing system, an information processing method, and a non-transitory computer readable medium.

### BACKGROUND ART

There is a technique that accepts registration of an apparatus owned by a user and displays a list of registered apparatuses on a display (hereinafter, referred to as “related art”). Examples of an apparatus that can be registered in related art include various home appliances.

Meanwhile, in recent years, for example, home appliances that can communicate with another apparatus via the Internet or the like are increasing (see Patent Literature 1). Such apparatuses including electronic apparatuses other than home appliances are generally called an Internet of Things (IoT) apparatuses.

### CITATION LIST

### Patent Literature

Patent Literature 1: JP 2013-125448 A

### SUMMARY OF INVENTION

### Technical Problem

An IoT apparatus is more convenient than a non-IoT apparatus because the IoT apparatus can communicate with another IoT apparatus via the Internet or the like. Therefore, a user may want to replace a non-IoT apparatus among apparatuses owned by the user with an IoT apparatus.

The user cannot find whether a registered apparatus is an IoT apparatus or a non-IoT apparatus even by looking at a list of apparatuses displayed by related art. Therefore, there is a problem that the user cannot specify a replacement target apparatus even by looking at the list of apparatuses.

The present disclosure has been made in order to solve the above problem, and an object of the present disclosure is to obtain a terminal device in which a user can check whether or not an owned apparatus is an IoT apparatus.

### Solution to Problem

A terminal device according to the present disclosure includes: processing circuitry configured to acquire apparatus information indicating a registered apparatus; acquire identification information indicating whether the apparatus is an IoT apparatus or a non-IoT apparatus from an apparatus management server by transmitting the acquired apparatus information to the apparatus management server; and generate display data indicating whether the apparatus is an IoT apparatus or a non-IoT apparatus on the basis of the acquired identification information, and output the display data.

### Advantageous Effects of Invention

According to the present disclosure, a user can check whether or not an owned apparatus is an IoT apparatus.

### BRIEF DESCRIPTION OF DRAWINGS

FIG. 1 is a configuration diagram illustrating an information processing system 1 according to a first embodiment.

FIG. 2 is a configuration diagram illustrating a terminal device 15 according to the first embodiment.

FIG. 3 is a hardware configuration diagram illustrating hardware of the terminal device 15 according to the first embodiment.

FIG. 4 is a hardware configuration diagram of a computer in a case where the terminal device 15 is implemented by software, firmware, or the like.

FIG. 5 is a configuration diagram illustrating an apparatus management server 16 according to the first embodiment.

FIG. 6 is a hardware configuration diagram illustrating hardware of the apparatus management server 16 according to the first embodiment.

FIG. 7 is a hardware configuration diagram of a computer in a case where the apparatus management server 16 is implemented by software, firmware, or the like.

FIG. 8 is a time chart illustrating main parts of processing procedures of an apparatus 11-n, the terminal device 15, and the apparatus management server 16.

FIG. 9 is a flowchart illustrating an information processing method which is a processing procedure performed in the terminal device 15 according to the first embodiment.

FIG. 10 is a flowchart illustrating a processing procedure performed in the apparatus management server 16 according to the first embodiment.

FIG. 11 is an explanatory diagram illustrating an example of a “bought item list” corresponding to a user who owns the apparatus 11-n.

FIG. 12 is an explanatory diagram illustrating an example of an apparatus identification table stored by an IoT-corresponding status storing unit 51.

FIG. 13 is an explanatory diagram illustrating an example of an identification image of the apparatus 11-n.

FIG. 14 is an explanatory diagram illustrating an example of control content of the apparatus 11-n.

FIG. 15 is a configuration diagram illustrating a terminal device 15 according to a second embodiment.

FIG. 16 is a hardware configuration diagram illustrating hardware of the terminal device 15 according to the second embodiment.

FIG. 17 is a configuration diagram illustrating an apparatus management server 16 according to the second embodiment.

FIG. 18 is a hardware configuration diagram illustrating hardware of the apparatus management server 16 according to the second embodiment.

FIG. 19 is a time chart illustrating main parts of processing procedures performed in an apparatus 11-n, the terminal device 15, and the apparatus management server 16.

FIG. 20 is an explanatory diagram illustrating an example of a combination of apparatuses capable of cooperating with each other in control.

FIG. 21 is an explanatory diagram illustrating an example of an execution status of cooperation control performed by an apparatus cooperation unit 83.

FIG. 22 is an explanatory diagram illustrating an example of an image indicating that execution of cooperation control is prioritized.

FIG. 23 is an explanatory diagram illustrating an example of an image illustrating that cooperation control is executed after control accepted by a control unit 27 is executed.

FIG. 24 is an explanatory diagram illustrating a display example of an execution status of cooperation control.

### DESCRIPTION OF EMBODIMENTS

Hereinafter, in order to describe the present disclosure in more detail, embodiments for carrying out the present disclosure will be described with reference to the attached drawings.

### First Embodiment

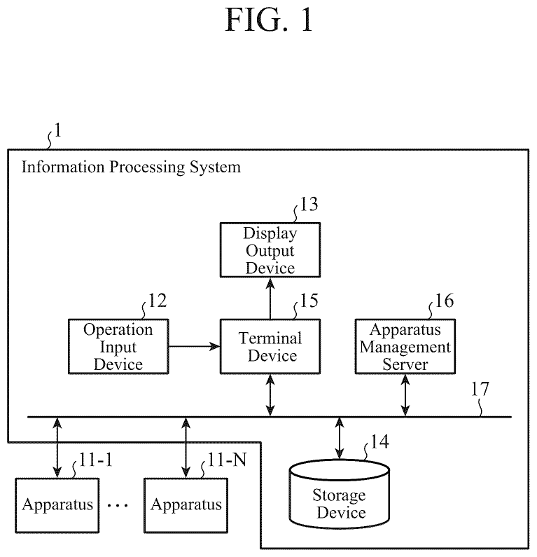

FIG. 1 is a configuration diagram illustrating an information processing system 1 according to a first embodiment.

The information processing system 1 illustrated in FIG. 1 includes an operation input device 12, a display output device 13, a storage device 14, a terminal device 15, an apparatus management server 16, and a network 17.

An apparatus 11-n (n=1, . . . , N) is a tangible object owned by a user and does not include electronic data stored in a storage medium. The tangible object includes, in addition to home appliances, a residential equipment apparatus, an in-vehicle apparatus, a factory automation (FA) apparatus, a building equipment apparatus, restaurant equipment, and the like. N is an integer equal to or more than 1.

In the information processing system 1 illustrated in FIG. 1, an example is illustrated in which all the apparatuses 11-1 to 11-N are connected to the network 17. However, an apparatus 11-n connected to the network 17 is an IoT apparatus, and an apparatus 11-n that is a non-IoT apparatus is not connected to the network 17.

Note that when an apparatus 11-n is a quasi-IoT apparatus that corresponds to IoT if a certain condition is satisfied, the apparatus 11-n is connected to the network 17. As the certain condition, a condition is considered in which, by connecting an adapter or the like that implements wireless local area network (LAN) communication or the like to an external connection terminal or the like of the apparatus 11-n, a communication function is retrofitted to the apparatus 11-n, and an external option that makes it possible to connect the apparatus 11-n to the network 17 is introduced. In addition, as the certain condition, a condition is considered in which an external option such as a smart infrared remote controller is introduced in the vicinity of an apparatus 11-n in order to make it possible to connect the apparatus 11-n to the network 17 and to make it possible for the terminal device 15 to remotely control the apparatus 11-n and to acquire an operation log of the apparatus 11-n. The smart infrared remote controller has a communication function such as wireless LAN communication that can transmit an infrared remote controller signal to an apparatus 11-n and intercept an infrared remote controller signal transmitted by a standard infrared remote controller attached to the apparatus 11-n.

The operation input device 12 is implemented by a man machine interface apparatus such as a keyboard, a mouse, a gesture operation recognition device, or a touch panel.

The operation input device 12 accepts an operation of a user (hereinafter, referred to as “user operation”) and outputs operation information indicating content of the user operation to the terminal device 15.

The information processing system 1 illustrated in FIG. 1 indicates a system in which the operation input device 12 is implemented by a keyboard, a mouse, a gesture operation recognition device, or a touch panel. However, this is merely an example, and the operation input device 12 may be implemented by, for example, a voice input device including a microphone that takes in a user's voice and a voice operation analyzing unit that converts the voice taken in by the microphone into an electric signal and generates operation information from the electric signal.

The display output device 13 includes a liquid crystal display, an organic electro luminescence (EL) display, or the like, and displays an image indicated by display data output from the terminal device 15 on the liquid crystal display or the like.

The storage device 14 includes a storage medium such as a solid state drive (SSD) or a hard disk drive (HDD). The storage device 14 writes information in a storage medium according to an information writing request from the outside, and reads information stored in the storage medium according to an information reading request from the outside.

The terminal device 15 is implemented by a general-purpose computer such as a personal computer, a portable terminal such as a smartphone or a tablet terminal, a dedicated integrated circuit, or the like.

In the information processing system 1 illustrated in FIG. 1, an example is illustrated in which the operation input device 12 and the display output device 13 are disposed outside the terminal device 15. However, in a case where the terminal device 15 is implemented by a portable terminal, the operation input device 12 and the display output device 13 may be disposed inside the terminal device 15.

The apparatus management server 16 is implemented by a general-purpose computer such as a personal computer, a dedicated integrated circuit, or the like.

The terminal device 15 and the apparatus management server 16 can transmit and receive information to and from each other via the network 17.

The network 17 is a communication network such as a LAN, a wireless LAN, long term evolution (LTE), fourth generation (4G), 5G, or an Internet line. Therefore, the terminal device 15 and the apparatus management server 16 are not necessarily connected to each other by a wide-area communication network such as an Internet line, and may be connected to each other, for example, only via a home LAN or a factory LAN.

When the information processing system 1 illustrated in FIG. 1 is, for example, an apparatus housed in one housing, the terminal device 15 and the apparatus management server 16 may transmit and receive information to and from each other via wiring in the apparatus.

The apparatus 11-n (n=1, . . . , N), the storage device 14, the terminal device 15, and the apparatus management server 16 are connected to the network 17.

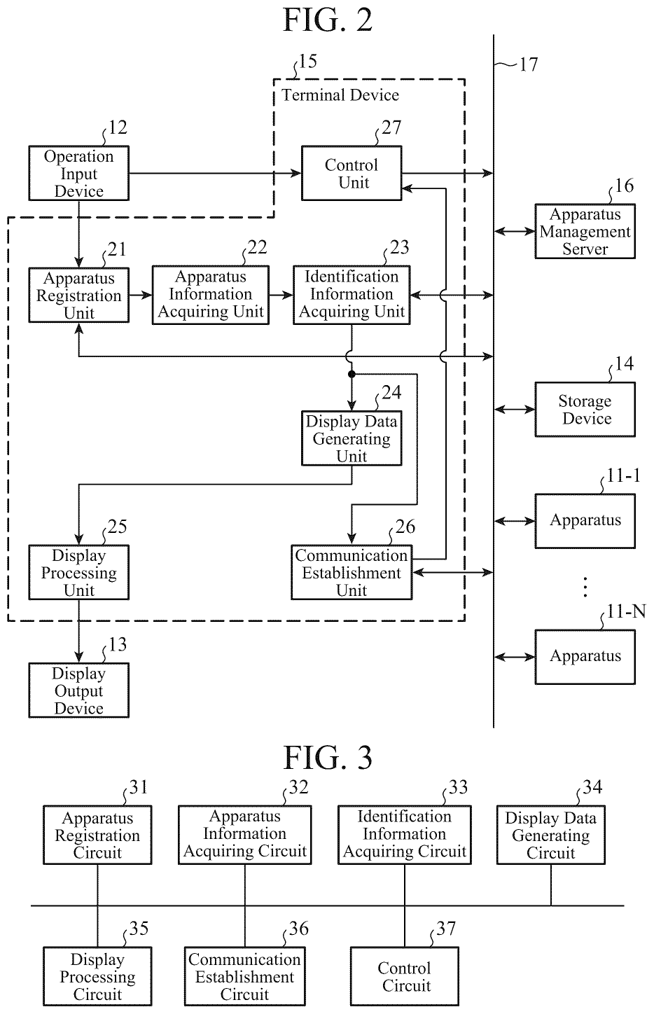

FIG. 2 is a configuration diagram illustrating the terminal device 15 according to the first embodiment.

FIG. 3 is a hardware configuration diagram illustrating hardware of the terminal device 15 according to the first embodiment.

The terminal device 15 illustrated in FIG. 2 includes an apparatus registration unit 21, an apparatus information acquiring unit 22, an identification information acquiring unit 23, a display data generating unit 24, a display processing unit 25, a communication establishment unit 26, and a control unit 27.

The apparatus registration unit 21 is implemented by, for example, an apparatus registration circuit 31.

The apparatus registration unit 21 acquires apparatus information indicating the apparatus 11-n (n=1, . . . , N) owned by a user from the operation input device 12.

The apparatus registration unit 21 registers the apparatus 11-n by adding the apparatus information to a “bought item list” described later. The “bought item list” may be stored in, for example, the storage device 14, or may be stored in an external storage device (not illustrated). In addition, the “bought item list” may be stored in an internal memory of the apparatus registration unit 21.

In the terminal device 15 illustrated in FIG. 2, the apparatus registration unit 21 acquires the apparatus information from the operation input device 12. However, this is merely an example, and for example, in a case where a barcode indicating apparatus information is stuck on the apparatus 11-n, a barcode reader (not illustrated) may read the barcode, and the apparatus registration unit 21 may acquire the apparatus information indicated by the barcode read by the barcode reader. In addition, the apparatus registration unit 21 may acquire the apparatus information from a purchase history remaining in a sales site of a supplier of the apparatus 11-n. In addition, a camera (not illustrated) may photograph a character string of an apparatus model number which is apparatus information described in a housing of the apparatus 11-n, a packing box of the apparatus 11-n, an instruction manual of the apparatus 11-n, or the like, and optical character recognition (OCR) may acquire the apparatus information from an image photographed by the camera.

The apparatus registration unit 21 outputs the acquired apparatus information to the apparatus information acquiring unit 22.

The apparatus information acquiring unit 22 is implemented by, for example, an apparatus information acquiring circuit 32.

The apparatus information acquiring unit 22 acquires the apparatus information output from the apparatus registration unit 21.

The apparatus information acquiring unit 22 outputs the acquired apparatus information to the identification information acquiring unit 23.

The identification information acquiring unit 23 is implemented by, for example, an identification information acquiring circuit 33.

The identification information acquiring unit 23 transmits the apparatus information acquired by the apparatus information acquiring unit 22 to the apparatus management server 16 via the network 17.

The identification information acquiring unit 23 acquires, from the apparatus management server 16 via the network 17, identification information indicating whether the apparatus 11-n is an IoT apparatus, a quasi-IoT apparatus that corresponds to IoT if a certain condition is satisfied, or a non-IoT apparatus.

The identification information acquiring unit 23 outputs the identification information to the display data generating unit 24 and the communication establishment unit 26.

The display data generating unit 24 is implemented by, for example, a display data generating circuit 34.

The display data generating unit 24 generates display data indicating whether the apparatus 11-n is an IoT apparatus, a quasi-IoT apparatus, or a non-IoT apparatus on the basis of the identification information acquired by the identification information acquiring unit 23.

The display data generating unit 24 outputs the display data to the display processing unit 25.

The display processing unit 25 is implemented by, for example, a display processing circuit 35.

The display processing unit 25 displays an image indicating whether the apparatus 11-n is an IoT apparatus, a quasi-IoT apparatus, or a non-IoT apparatus on a display of the display output device 13 according to the display data generated by the display data generating unit 24.

The communication establishment unit 26 is implemented by, for example, a communication establishment circuit 36.

The communication establishment unit 26 recognizes whether the apparatus 11-n is an IoT apparatus, a quasi-IoT apparatus, or a non-IoT apparatus on the basis of the identification information output from the identification information acquiring unit 23.

When the apparatus 11-n registered by the apparatus registration unit 21 is an IoT apparatus or a quasi-IoT apparatus satisfying the certain condition, the communication establishment unit 26 establishes communication between the apparatus 11-n and the terminal device 15. When the apparatus 11-n is a quasi-IoT apparatus, information indicating whether or not the certain condition is satisfied may be supplied, for example, from the operation input device 12 or from the outside of the information processing system 1.

The communication establishment unit 26 outputs communication establishment information indicating the apparatus 11-n that has established communication with the terminal device 15 to the control unit 27.

The control unit 27 is implemented by, for example, a control circuit 37.

The control unit 27 acquires the communication establishment information from the communication establishment unit 26.

In addition to accepting control of the apparatus 11-n indicated by the communication establishment information, the control unit 27 accepts, for example, an instruction to acquire monitoring information indicating a latest state or the like of the apparatus 11-n.

When accepting the control of the apparatus 11-n, the control unit 27 controls the apparatus 11-n by executing a control application of the apparatus 11-n.

Note that the control application of the apparatus 11-n may be executed by the control unit 27, but the control unit 27 may supply the control application to the apparatus 11-n, and the apparatus 11-n may execute the control application. In addition, the control unit 27 may supply the control application of the apparatus 11-n to the apparatus management server 16, and the apparatus management server 16 may execute the control application.

In FIG. 2, it is assumed that each of the apparatus registration unit 21, the apparatus information acquiring unit 22, the identification information acquiring unit 23, the display data generating unit 24, the display processing unit 25, the communication establishment unit 26, and the control unit 27, which are constituent elements of the terminal device 15, is implemented by dedicated hardware as illustrated in FIG. 3. That is, it is assumed that the terminal device 15 is implemented by the apparatus registration circuit 31, the apparatus information acquiring circuit 32, the identification information acquiring circuit 33, the display data generating circuit 34, the display processing circuit 35, the communication establishment circuit 36, and the control circuit 37.

To each of the apparatus registration circuit 31, the apparatus information acquiring circuit 32, the identification information acquiring circuit 33, the display data generating circuit 34, the display processing circuit 35, the communication establishment circuit 36, and the control circuit 37, for example, a single circuit, a composite circuit, a programmed processor, a parallel-programmed processor, an application specific integrated circuit (ASIC), a field-programmable gate array (FPGA), or a combination thereof corresponds.

The constituent elements of the terminal device 15 are not limited to those implemented by dedicated hardware, and the terminal device 15 may be implemented by software, firmware, or a combination of software and firmware.

Software or firmware is stored as a program in a memory of a computer. The computer means hardware for executing a program. For example, to the computer, a central processing unit (CPU), a central processing device, a processing device, an arithmetic device, a microprocessor, a microcomputer, a processor, or a digital signal processor (DSP) corresponds.

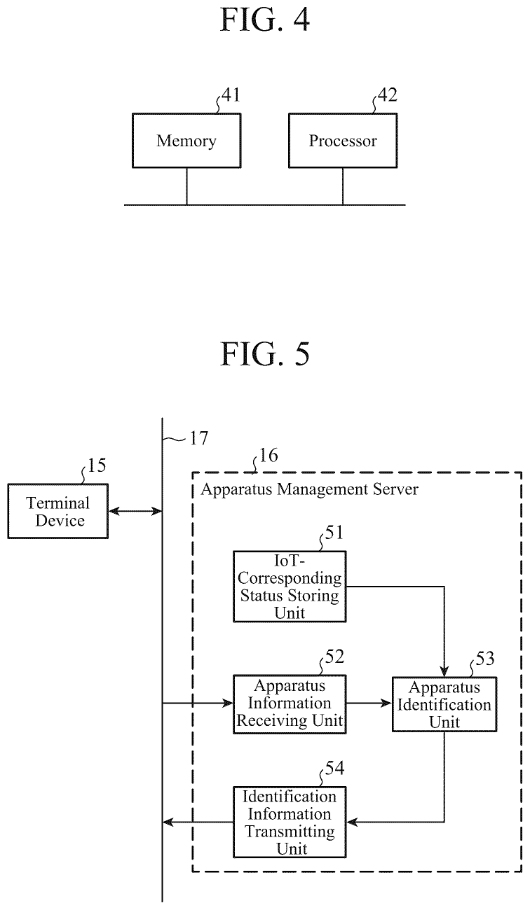

FIG. 4 is a hardware configuration diagram of a computer in a case where the terminal device 15 is implemented by software, firmware, or the like.

In a case where the terminal device 15 is implemented by software, firmware, or the like, an information processing program for causing the computer to execute a processing procedure performed in each of the apparatus registration unit 21, the apparatus information acquiring unit 22, the identification information acquiring unit 23, the display data generating unit 24, the display processing unit 25, the communication establishment unit 26, and the control unit 27 is stored in a memory 41. A processor 42 of the computer executes the information processing program stored in the memory 41.

FIG. 3 illustrates an example in which each of the constituent elements of the terminal device 15 is implemented by dedicated hardware, and FIG. 4 illustrates an example in which the terminal device 15 is implemented by software, firmware, or the like. However, this is merely an example, and some of the constituent elements of the terminal device 15 may be implemented by dedicated hardware, and the remaining constituent elements may be implemented by software, firmware, or the like.

FIG. 5 is a configuration diagram illustrating the apparatus management server 16 according to the first embodiment.

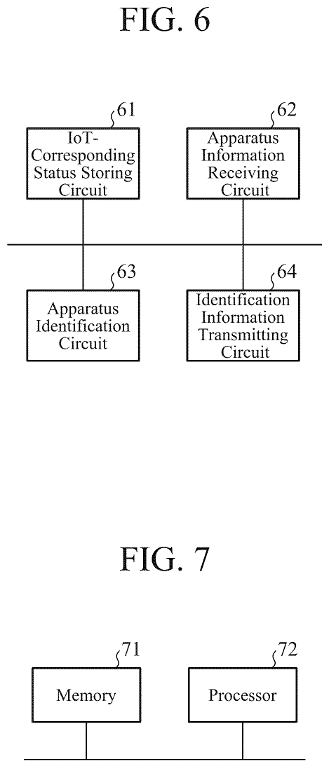

FIG. 6 is a hardware configuration diagram illustrating hardware of the apparatus management server 16 according to the first embodiment.

The apparatus management server 16 illustrated in FIG. 5 includes an IoT-corresponding status storing unit 51, an apparatus information receiving unit 52, an apparatus identification unit 53, and an identification information transmitting unit 54.

The IoT-corresponding status storing unit 51 is implemented by, for example, an IoT-corresponding status storing circuit 61 illustrated in FIG. 6.

The IoT-corresponding status storing unit 51 stores an apparatus identification table indicating whether the apparatus 11-n indicated by apparatus information is an IoT apparatus, a quasi-IoT apparatus, or a non-IoT apparatus.

The apparatus information receiving unit 52 is implemented by, for example, an apparatus information receiving circuit 62 illustrated in FIG. 6.

The apparatus information receiving unit 52 receives apparatus information indicating the apparatus 11-n registered by the apparatus registration unit 21 from the identification information acquiring unit 23 of the terminal device 15 via the network 17.

The apparatus information receiving unit 52 outputs the apparatus information to the apparatus identification unit 53.

The apparatus identification unit 53 is implemented by, for example, an apparatus identification circuit 63 illustrated in FIG. 6.

The apparatus identification unit 53 acquires the apparatus information from the apparatus information receiving unit 52.

The apparatus identification unit 53 refers to the apparatus identification table stored by the IoT-corresponding status storing unit 51, and identifies whether the apparatus 11-n indicated by the apparatus information is an IoT apparatus, a quasi-IoT apparatus, or a non-IoT apparatus.

The apparatus identification unit 53 outputs identification information indicating whether the apparatus 11-n is an IoT apparatus, a quasi-IoT apparatus, or a non-IoT apparatus to the identification information transmitting unit 54.

In the information processing system 1 illustrated in FIG. 1, it is assumed that the IoT-corresponding status storing unit 51 stores the apparatus identification table, and the apparatus identification unit 53 refers to the apparatus identification table stored by the IoT-corresponding status storing unit 51. However, this is merely an example, and for example, when a server of a manufacturer of the apparatus 11-n stores the apparatus identification table, the apparatus identification unit 53 may refer to the apparatus identification table stored by the server of the manufacturer.

The identification information transmitting unit 54 is implemented by, for example, an identification information transmitting circuit 64 illustrated in FIG. 6.

The identification information transmitting unit 54 acquires the identification information output from the apparatus identification unit 53.

The identification information transmitting unit 54 transmits the identification information to the identification information acquiring unit 23 of the terminal device 15 via the network 17.

In FIG. 5, it is assumed that each of the IoT-corresponding status storing unit 51, the apparatus information receiving unit 52, the apparatus identification unit 53, and the identification information transmitting unit 54, which are constituent elements of the apparatus management server 16, is implemented by dedicated hardware as illustrated in FIG. 6. That is, it is assumed that the apparatus management server 16 is implemented by the IoT-corresponding status storing circuit 61, the apparatus information receiving circuit 62, the apparatus identification circuit 63, and the identification information transmitting circuit 64.

Here, to the IoT-corresponding status storing circuit 61, for example, a nonvolatile or volatile semiconductor memory such as a random access memory (RAM), a read only memory (ROM), a flash memory, an erasable programmable read only memory (EPROM), or an electrically erasable programmable read only memory (EEPROM), a magnetic disk, a flexible disk, an optical disc, a compact disc, a mini disc, or a digital versatile disc (DVD) corresponds.

To each of the apparatus information receiving circuit 62, the apparatus identification circuit 63, and the identification information transmitting circuit 64, for example, a single circuit, a composite circuit, a programmed processor, a parallel programmed processor, an ASIC, a FPGA, or a combination thereof corresponds.

The constituent elements of the apparatus management server 16 are not limited to those implemented by dedicated hardware, and the apparatus management server 16 may be implemented by software, firmware, or a combination of software and firmware.

FIG. 7 is a hardware configuration diagram of a computer in a case where the apparatus management server 16 is implemented by software, firmware, or the like.

In a case where the apparatus management server 16 is implemented by software, firmware, or the like, the IoT-corresponding status storing unit 51 is constituted on a memory 71 of the computer. A program for causing the computer to execute a processing procedure performed in each of the apparatus information receiving unit 52, the apparatus identification unit 53, and the identification information transmitting unit 54 is stored in the memory 71. A processor 72 of the computer executes the program stored in the memory 71.

FIG. 6 illustrates an example in which each of the constituent elements of the apparatus management server 16 is implemented by dedicated hardware, and FIG. 7 illustrates an example in which the apparatus management server 16 is implemented by software, firmware, or the like. However, this is merely an example, and some of the constituent elements of the apparatus management server 16 may be implemented by dedicated hardware, and the remaining constituent elements may be implemented by software, firmware, or the like.

Next, an operation of the information processing system 1 illustrated in FIG. 1 will be described.

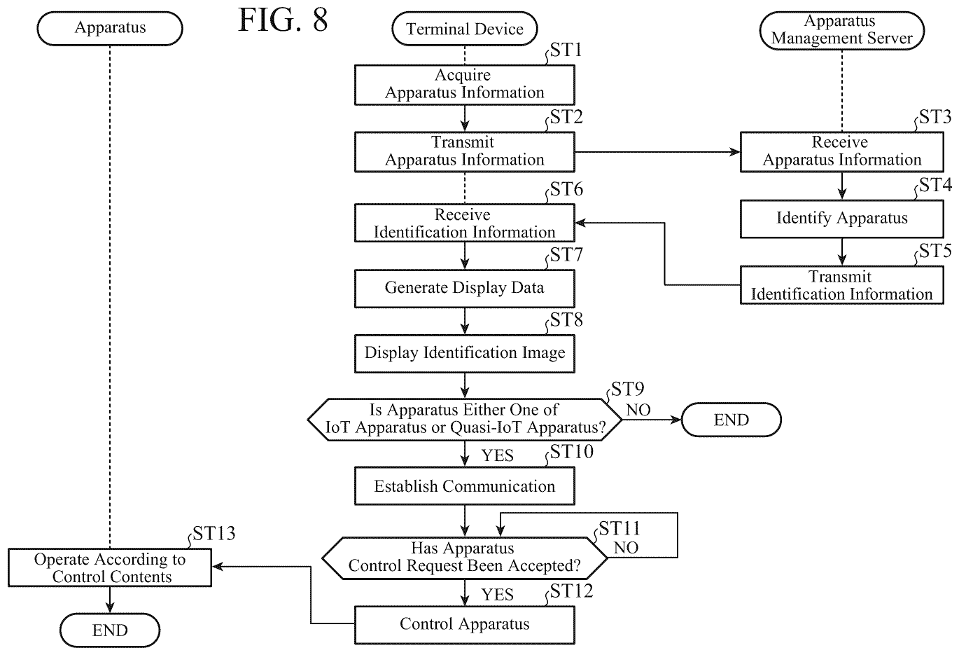

FIG. 8 is a time chart illustrating main parts of processing procedures performed in the apparatus 11-n, the terminal device 15, and the apparatus management server 16.

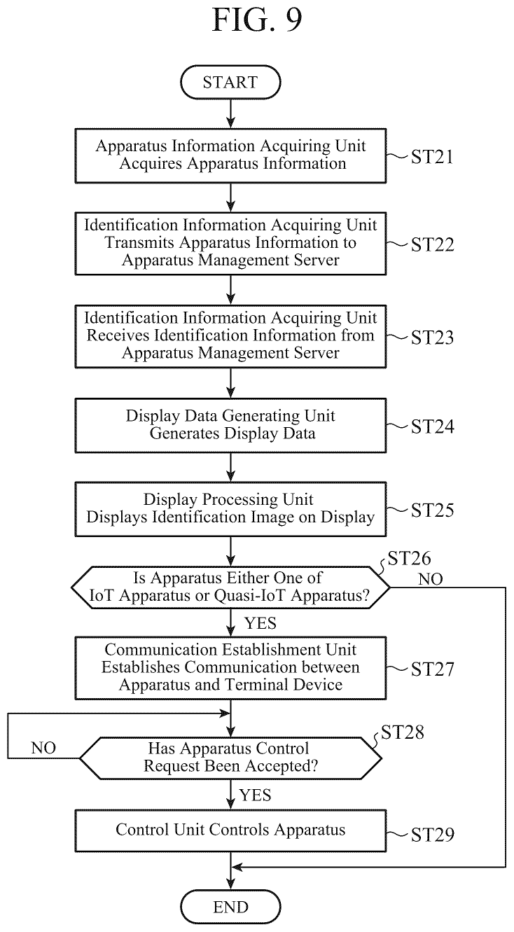

FIG. 9 is a flowchart illustrating an information processing method which is a processing procedure performed in the terminal device 15 according to the first embodiment.

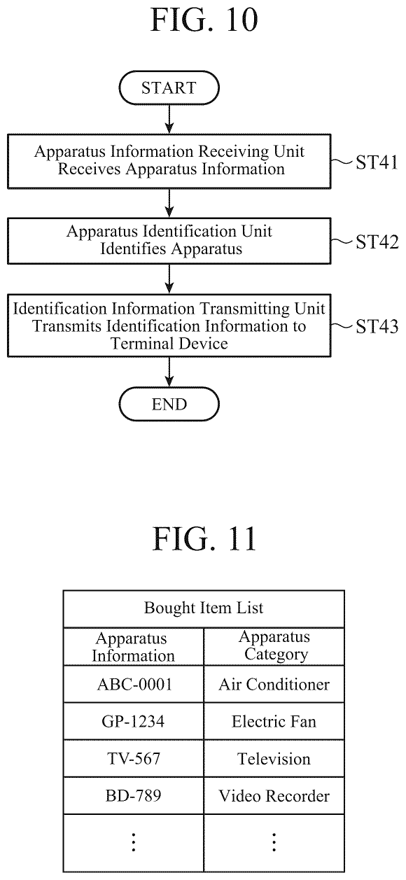

FIG. 10 is a flowchart illustrating a processing procedure performed in the apparatus management server 16 according to the first embodiment.

The operation input device 12 accepts, for example, a registration operation of the apparatus 11-n (n=1, . . . , N) owned by a user as a user operation.

The registration operation of the apparatus 11-n is an operation of accepting an input of apparatus information indicating the apparatus 11-n.

In addition, the registration operation of the apparatus 11-n is an operation of accepting, for example, an input of a user identification (ID) as user identification information for identifying the user.

When accepting the input of the apparatus information indicating the apparatus 11-n and the user identification information, the operation input device 12 outputs an apparatus registration request including the apparatus information and the user identification information to the apparatus registration unit 21 of the terminal device 15.

The apparatus registration unit 21 of the terminal device 15 acquires the apparatus registration request output from the operation input device 12.

The apparatus registration unit 21 causes the storage device 14 to register the apparatus 11-n by transmitting the apparatus registration request to the storage device 14 via the network 17.

When receiving the apparatus registration request from the apparatus registration unit 21, the storage device 14 adds the apparatus information included in the apparatus registration request to the “bought item list” corresponding to the user indicated by the user identification information included in the apparatus registration request.

By the apparatus information being added to the “bought item list” corresponding to the user, the apparatus 11-n is registered in the “bought item list”.

FIG. 11 is an explanatory diagram illustrating an example of the “bought item list” corresponding to the user who owns the apparatus 11-n.

In the example of FIG. 11, an air conditioner whose apparatus information is “ABC-0001”, an electric fan whose apparatus information is “GP-1234”, a television whose apparatus information is “TV-567”, and a video recorder whose apparatus information is “BD-789” are registered in the “bought item list”.

In the information processing system 1 illustrated in FIG. 1, the apparatus registration unit 21 directly causes the storage device 14 to register the apparatus 11-n. However, this is merely an example, and by the apparatus registration unit 21 transmitting the apparatus registration request to the apparatus management server 16, the apparatus management server 16 may cause the storage device 14 to register the apparatus 11-n.

In the “bought item list”, not only an IoT apparatus and a quasi-IoT apparatus but also a non-IoT apparatus is registered.

The storage device 14 transmits apparatus information indicating all the apparatuses 11-1 to 11-N registered in the “bought item list” corresponding to the user indicated by the user identification information to the apparatus registration unit 21 of the terminal device 15 via the network 17.

The apparatus registration unit 21 receives the apparatus information indicating all the registered apparatuses 11-1 to 11-N from the storage device 14 via the network 17.

The apparatus registration unit 21 outputs the apparatus information indicating all the registered apparatuses 11-1 to 11-N to the apparatus information acquiring unit 22.

The apparatus information acquiring unit 22 of the terminal device 15 acquires the apparatus information indicating all the registered apparatuses 11-1 to 11-N from the apparatus registration unit 21 (step ST1 in FIG. 8 and step ST21 in FIG. 9).

The apparatus information acquiring unit 22 outputs the apparatus information indicating all the registered apparatuses 11-1 to 11-N to the identification information acquiring unit 23.

The identification information acquiring unit 23 of the terminal device 15 transmits the apparatus information indicating the apparatus 11-n (n=1, . . . , N) to the apparatus information receiving unit 52 of the apparatus management server 16 via the network 17 (step ST2 in FIG. 8 and step ST22 in FIG. 9).

The apparatus information receiving unit 52 of the apparatus management server 16 receives the apparatus information indicating the apparatus 11-n from the identification information acquiring unit 23 of the terminal device 15 via the network 17 (step ST3 in FIG. 8 and step ST41 in FIG. 10).

The apparatus information receiving unit 52 outputs the apparatus information to the apparatus identification unit 53.

The apparatus identification unit 53 of the apparatus management server 16 acquires the apparatus information from the apparatus information receiving unit 52.

The apparatus identification unit 53 refers to the apparatus identification table stored by the IoT-corresponding status storing unit 51, and identifies whether the apparatus 11-n indicated by the apparatus information is an IoT apparatus, a quasi-IoT apparatus, or a non-IoT apparatus (step ST4 in FIG. 8 and step ST42 in FIG. 10).

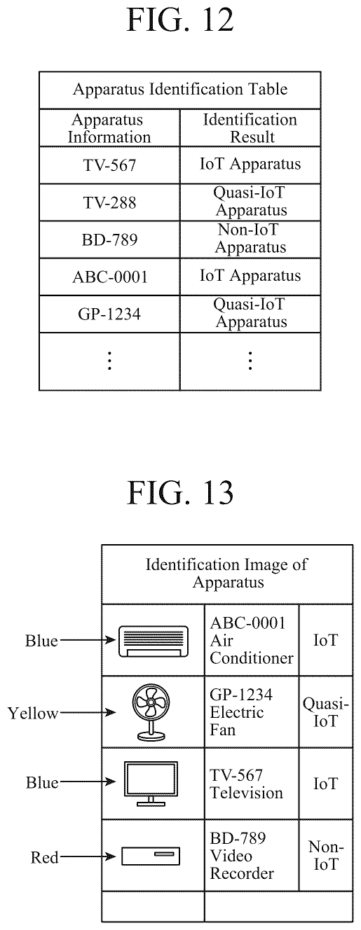

FIG. 12 is an explanatory diagram illustrating an example of the apparatus identification table stored by the IoT-corresponding status storing unit 51.

In the example of FIG. 12, a television whose apparatus information is “TV-567” is an IoT apparatus, a television whose apparatus information is “TV-288” is a quasi-IoT apparatus, and a video recorder whose apparatus information is “BD-789” is a non-IoT apparatus. In addition, an air conditioner whose apparatus information is “ABC-0001” is an IoT apparatus, and an electric fan whose apparatus information is “GP-1234” is a quasi-IoT apparatus.

The apparatus identification unit 53 outputs identification information indicating whether the apparatus 11-n is an IoT apparatus, a quasi-IoT apparatus, or a non-IoT apparatus to the identification information transmitting unit 54.

The apparatus identification table illustrated in FIG. 12 stores not only the identification result of the IoT apparatus and the identification result of the quasi-IoT apparatus but also the identification result of the non-IoT apparatus.

The identification information transmitting unit 54 of the apparatus management server 16 acquires the identification information from the apparatus identification unit 53.

The identification information transmitting unit 54 transmits the identification information to the identification information acquiring unit 23 of the terminal device 15 via the network 17 (step ST5 in FIG. 8 and step ST43 in FIG. 10).

The identification information acquiring unit 23 of the terminal device 15 receives the identification information from the identification information transmitting unit 54 of the apparatus management server 16 via the network 17 (step ST6 in FIG. 8 and step ST23 in FIG. 9).

The identification information acquiring unit 23 outputs the identification information to the display data generating unit 24 and the communication establishment unit 26.

The display data generating unit 24 of the terminal device 15 acquires the identification information from the identification information acquiring unit 23.

The display data generating unit 24 generates display data indicating whether the apparatus 11-n is an IoT apparatus, a quasi-IoT apparatus, or a non-IoT apparatus on the basis of the identification information (step ST7 in FIG. 8 and step ST24 in FIG. 9).

The display data generating unit 24 outputs the display data to the display processing unit 25.

The display processing unit 25 of the terminal device 15 acquires the display data from the display data generating unit 24.

The display processing unit 25 displays an identification image which is an image indicating whether the apparatus 11-n is an IoT apparatus, a quasi-IoT apparatus, or a non-IoT apparatus on a display of the display output device 13 according to the display data generated by the display data generating unit 24 (step ST8 in FIG. 8 and step ST25 in FIG. 9).

FIG. 13 is an explanatory diagram illustrating an example of the identification image of the apparatus 11-n.

In FIG. 13, the identification image of the apparatus 11-n is color-coded. When the apparatus 11-n is an IoT apparatus, the apparatus 11-n is displayed in, for example, blue. When the apparatus 11-n is a quasi-IoT apparatus, the apparatus 11-n is displayed in, for example, yellow. When the apparatus 11-n is a non-IoT apparatus, the apparatus 11-n is displayed in, for example, red.

FIG. 13 illustrates an example in which the identification image of the apparatus 11-n is color-coded. It is not limited to one in which the identification image is color-coded as long as it is possible to identify whether the apparatus 11-n is an IoT apparatus, a quasi-IoT apparatus, or a non-IoT apparatus. For example, an icon (1) indicating that the apparatus 11-n is an IoT apparatus, an icon (2) indicating that the apparatus 11-n is a quasi-IoT apparatus, and an icon (3) indicating that the apparatus 11-n is a non-IoT apparatus may be displayed. In addition, a character string (1) indicating that the apparatus 11-n is an IoT apparatus, a character string (2) indicating that the apparatus 11-n is a quasi-IoT apparatus, and a character string (3) indicating that the apparatus 11-n is a non-IoT apparatus may be displayed. In addition, in the list display indicating the list of the apparatuses 11-n, an apparatus list in which the apparatuses 11-n are sorted into an IoT apparatus, a quasi-IoT apparatus, and a non-IoT apparatus may be displayed.

Since the identification image of the apparatus 11-n illustrated in FIG. 13 is the identification images of all the apparatuses 11-1 to 11-N registered in the “bought item list”, by the identification image of the apparatus 11-n illustrated in FIG. 13 being displayed on a display, the user can grasp his or her owned apparatuses 11-n. Manual data indicating instruction manuals of all the apparatuses 11-1 to 11-N may be downloaded from manufacturers and the like of the apparatuses. In this case, when the user touches an identification image or the like of any one of the apparatuses 11-n among the identification images and the like of the apparatuses 11-1 to 11-N displayed on the display, an instruction manual of the apparatus 11-n may be displayed on the display. As a result, the user can unitarily manage the instruction manuals of the owned apparatuses 11-n. As described above, a trigger for the user to manage the list of the owned apparatuses 11-n using the terminal device 15 is not necessarily a desire to use an IoT function, but may be, for example, another desire to unitarily manage the instruction manuals of the apparatuses 11-n. Note that, although the case where the instruction manual is displayed has been exemplified here, an official website regarding the apparatus 11-n provided by a manufacturer or the like, information related to the apparatus such as frequently asked questions (FAQ), or a list of related information in which these pieces of information are collected as a list may be displayed.

The communication establishment unit 26 of the terminal device 15 acquires the identification information from the identification information acquiring unit 23.

The communication establishment unit 26 recognizes whether the apparatus 11-n is an IoT apparatus, a quasi-IoT apparatus, or a non-IoT apparatus on the basis of the identification information.

If the apparatus 11-n is an IoT apparatus or a quasi-IoT apparatus satisfying the certain condition (step ST9 in FIG. 8: YES or step ST26 in FIG. 9: YES), the communication establishment unit 26 establishes communication between the apparatus 11-n and the terminal device 15 (step ST10 in FIG. 8 and step ST27 in FIG. 9).

The establishment of communication between the apparatus 11-n and the terminal device 15 means setting a state in which the apparatus 11-n and the terminal device 15 can wirelessly communicate with each other by connecting the apparatus 11-n to, for example, a wireless LAN.

Note that when the apparatus 11-n is a quasi-IoT apparatus, the information indicating whether or not the certain condition is satisfied may be supplied, for example, from the operation input device 12 or from the outside of the terminal device 15.

If the apparatus 11-n is a quasi-IoT apparatus that does not satisfy the certain condition or a non-IoT apparatus (step ST9 in FIG. 8: NO or step ST26 in FIG. 9: NO), the communication establishment unit 26 does not perform the processing of establishing communication between the apparatus 11-n and the terminal device 15.

The communication establishment unit 26 outputs communication establishment information indicating the apparatus 11-n that has established communication with the terminal device 15 to the control unit 27.

In order to clearly indicate an apparatus for which communication is established by the communication establishment unit 26 among the apparatuses 11-1 to 11-N, the display data generating unit 24 may generate display data indicating an icon or the like for distinguishing between an apparatus for which communication has been established and an apparatus for which communication has not been established, and the display processing unit 25 may display the icon or the like on the display according to the display data generated by the display data generating unit 24.

The operation input device 12 accepts, for example, a control operation of the apparatus 11-n as a user operation.

The control operation of the apparatus 11-n is an operation of accepting apparatus information indicating the apparatus 11-n and control content of the apparatus 11-n.

The operation input device 12 outputs an apparatus control request including the apparatus information and the control content to the control unit 27 of the terminal device 15.

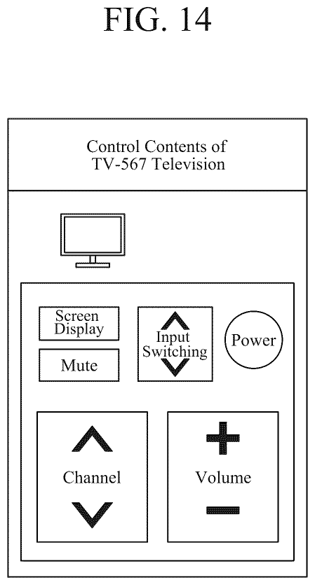

FIG. 14 is an explanatory diagram illustrating an example of the control content of the apparatus 11-n.

In the example of FIG. 14, the apparatus 11-n is a television of “TV-567”, and the control content includes channel switching, volume change, power on/off, input switching, screen display, and silencing.

In a case where the identification image of the apparatus 11-n illustrated in FIG. 13 is displayed on the display, when a user touches any one of an apparatus image indicating the television of “TV-567”, “TV-567” which is apparatus information of the television, and “IoT” corresponding to the television of “TV-567”, the control content of the apparatus 11-n illustrated in FIG. 14 is displayed on the display.

Here, an example is illustrated in which display on the display is switched from the identification image of the apparatus 11-n illustrated in FIG. 13 to the control content of the apparatus 11-n illustrated in FIG. 14. However, this is merely an example, and in the middle of switching from the identification image of the apparatus 11-n illustrated in FIG. 13 to the control content of the apparatus 11-n illustrated in FIG. 14, another screen indicating detailed information of the apparatus 11-n may be displayed on the display, and the display may be switched from the another screen to the control content of the apparatus 11-n illustrated in FIG. 14. In addition, the control content of the apparatus 11-n illustrated in FIG. 14 may be superimposed and displayed on a residual image of the identification image of the apparatus 11-n illustrated in FIG. 13 while the residual image is left in the background. In addition, for example, the control content of the apparatus 11-n illustrated in FIG. 14 may be displayed in a lower half of the display while the identification image of the apparatus 11-n illustrated in FIG. 13 is displayed, for example, in a drawing area reduced to an upper half of the display.

The control unit 27 of the terminal device 15 acquires the communication establishment information from the communication establishment unit 26.

When the apparatus 11-n indicated by the apparatus information included in the apparatus control request output from the operation input device 12 is an apparatus indicated by the communication establishment information, the control unit 27 accepts the apparatus control request output from the operation input device 12.

When the apparatus 11-n is a quasi-IoT apparatus, the information indicating whether or not the certain condition is satisfied may be supplied, for example, from the operation input device 12 or from the outside of the terminal device 15.

If the control unit 27 has accepted the apparatus control request (step ST11 in FIG. 8: YES or step ST28 in FIG. 9: YES), the control unit 27 controls the apparatus 11-n indicated by the apparatus information included in the apparatus control request by executing a control application for implementing the control content included in the apparatus control request (step ST12 in FIG. 8 and step ST29 in FIG. 9).

The apparatus 11-n operates according to the control content (step ST13 in FIG. 8).

If the control unit 27 has not accepted the apparatus control request (step ST11: NO in FIG. 8 or step ST28: NO in FIG. 9), the control unit 27 waits until the control unit 27 accepts the apparatus control request.

When the control application of the apparatus 11-n is distributed from, for example, the server of the manufacturer of the apparatus 11-n, the control unit 27 can download the control application of the apparatus 11-n from the server of the manufacturer.

In addition, the control application of the apparatus 11-n may be a mini-application that indirectly controls the apparatus 11-n by controlling a control driver of the apparatus 11-n instead of an application that directly controls the apparatus 11-n. The control driver is included in another control software distributed in advance from the server of the manufacturer, a cloud service corresponding to the IoT of the manufacturer, or plug-in software of any home gateway device or router device. The control unit 27 indirectly controls the apparatus 11-n by controlling the control driver on the basis of an operation instruction of the mini-application by a user. In a case where the control application of the apparatus 11-n is a mini-application, the manufacturer of the apparatus 11-n reduces development cost of the control application as compared with a case of developing the application that directly controls the apparatus 11-n. The mini-application may be developed by a manufacturer other than the manufacturer of the apparatus 11-n.

The control application that directly controls the apparatus 11-n is generally a full-specification application installed in an operating system, and the number of development steps is enormous. The mini-application is an application that operates in a unique environment in the full-specification application that manages the apparatus 11-n, and has a fewer number of development steps than the full-specification application. Therefore, in a case where the control application of the apparatus 11-n is a mini-application, the manufacturer or the like of the apparatus 11-n reduces development cost of the control application as compared with a case of developing the full-specification application that directly controls the apparatus 11-n.

In addition, the control application does not need to be a dedicated application for the apparatus 11-n, and may be a common control application capable of controlling a plurality of apparatuses belonging to an apparatus category to which the apparatus 11-n belongs. When the apparatus category is, for example, a category for an air conditioner, a control application common in controlling a plurality of air conditioners manufactured by the manufacturer of the apparatus 11-n or a control application common in controlling an air conditioner manufactured by the manufacturer of the apparatus 11-n and an air conditioner manufactured by a manufacturer different from the manufacturer of the apparatus 11-n can be considered. In addition, when the apparatus category is, for example, a category for a television, a control application common in controlling a plurality of televisions manufactured by the manufacturer of the apparatus 11-n or a control application common in controlling a television manufactured by the manufacturer of the apparatus 11-n and a television manufactured by a manufacturer different from the manufacturer of the apparatus 11-n can be considered. The common control application may be supplied by a third party different from the manufacturers of the apparatuses.

Note that the control application of the apparatus 11-n may be executed by the control unit 27, but the control unit 27 may supply the control application to the apparatus 11-n, and the apparatus 11-n may execute the control application. In addition, the control unit 27 may supply the control application of the apparatus 11-n to the apparatus management server 16, and the apparatus management server 16 may execute the control application.

In the above first embodiment, the terminal device 15 is configured to include: the apparatus information acquiring unit 22 that acquires apparatus information indicating a registered apparatus 11-n; the identification information acquiring unit 23 that acquires identification information indicating whether the apparatus 11-n is an IoT apparatus or a non-IoT apparatus from the apparatus management server 16 by transmitting the apparatus information acquired by the apparatus information acquiring unit 22 to the apparatus management server 16; and the display data generating unit 24 that generates display data indicating whether the apparatus 11-n is an IoT apparatus or a non-IoT apparatus on the basis of the identification information acquired by the identification information acquiring unit 23, and outputs the display data. Therefore, with the terminal device 15, a user can check whether or not an owned apparatus is an IoT apparatus.

### Second Embodiment

In a second embodiment, an information processing system 1 in which a terminal device 15 includes an apparatus cooperation unit 83 that performs cooperation control between apparatuses capable of cooperating with each other in control will be described.

The configuration of the information processing system 1 according to the second embodiment is similar to the configuration of the information processing system 1 according to the first embodiment, and a configuration diagram illustrating the information processing system 1 according to the second embodiment is illustrated in FIG. 1.

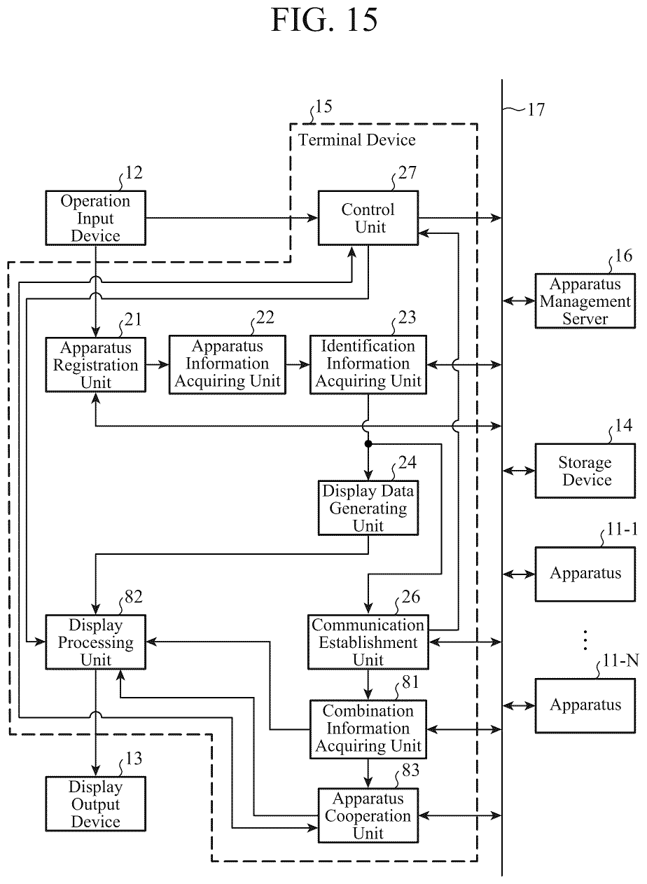

FIG. 15 is a configuration diagram illustrating the terminal device 15 according to the second embodiment. In FIG. 15, the same reference numerals as in FIG. 2 indicate the same or corresponding parts, and therefore description thereof is omitted.

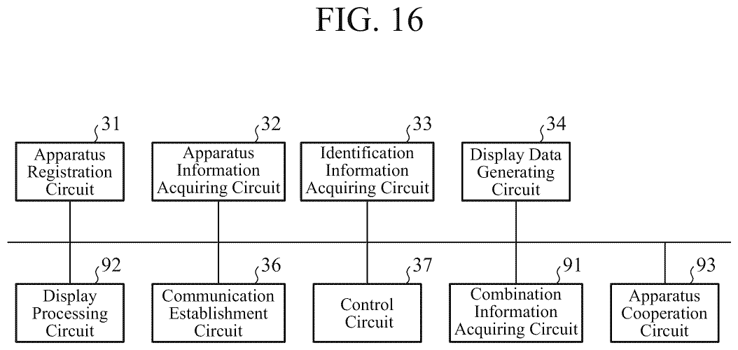

FIG. 16 is a hardware configuration diagram illustrating hardware of the terminal device 15 according to the second embodiment. In FIG. 16, the same reference numerals as in FIG. 3 indicate the same or corresponding parts, and therefore description thereof is omitted.

A combination information acquiring unit 81 is implemented by, for example, a combination information acquiring circuit 91 illustrated in FIG. 16.

When there are two or more apparatuses 11-n whose communication with the terminal device 15 is established by a communication establishment unit 26, the combination information acquiring unit 81 transmits apparatus information indicating each of the apparatuses 11-n to an apparatus management server 16 via a network 17.

The combination information acquiring unit 81 acquires, from the apparatus management server 16, combination information indicating a combination of apparatuses 11-n capable of cooperating with each other in control among the two or more apparatuses 11-n.

The combination information acquiring unit 81 outputs the combination information to each of a display processing unit 82 and the apparatus cooperation unit 83.

The display processing unit 82 is implemented by, for example, a display processing circuit 92.

Similarly to the display processing unit 25 illustrated in FIG. 2, the display processing unit 82 displays an image indicating whether the apparatus 11-n is an IoT apparatus, a quasi-IoT apparatus, or a non-IoT apparatus on a display of a display output device 13 according to display data generated by a display data generating unit 24.

The display processing unit 82 displays an image indicating a combination of the apparatuses 11-n indicated by the combination information acquired by the combination information acquiring unit 81 on the display of the display output device 13.

In addition, the display processing unit 82 displays an execution status of the cooperation control performed by the apparatus cooperation unit 83 on the display of the display output device 13.

The apparatus cooperation unit 83 is implemented by, for example, an apparatus cooperation circuit 93.

The apparatus cooperation unit 83 acquires the combination information output from the combination information acquiring unit 81.

The apparatus cooperation unit 83 recognizes a combination of apparatuses 11-n capable of cooperating with each other in control among the two or more apparatuses 11-n on the basis of the combination information.

The apparatus cooperation unit 83 acquires a cooperation application for performing cooperation control between apparatuses 11-n capable of cooperating with each other in control.

The apparatus cooperation unit 83 performs cooperation control between the apparatuses 11-n using the cooperation application.

In FIG. 15, it is assumed that each of an apparatus registration unit 21, an apparatus information acquiring unit 22, an identification information acquiring unit 23, a display data generating unit 24, a display processing unit 82, a communication establishment unit 26, a control unit 27, the combination information acquiring unit 81, and the apparatus cooperation unit 83, which are constituent elements of the terminal device 15, is implemented by dedicated hardware as illustrated in FIG. 16. That is, it is assumed that the terminal device 15 is implemented by an apparatus registration circuit 31, an apparatus information acquiring circuit 32, an identification information acquiring circuit 33, a display data generating circuit 34, the display processing circuit 92, a communication establishment circuit 36, a control circuit 37, the combination information acquiring circuit 91, and the apparatus cooperation circuit 93.

To each of the apparatus registration circuit 31, the apparatus information acquiring circuit 32, the identification information acquiring circuit 33, the display data generating circuit 34, the display processing circuit 92, the communication establishment circuit 36, the control circuit 37, the combination information acquiring circuit 91, and the apparatus cooperation circuit 93, for example, a single circuit, a composite circuit, a programmed processor, a parallel-programmed processor, ASIC, FPGA, or a combination thereof corresponds.

The constituent elements of the terminal device 15 are not limited to those implemented by dedicated hardware, and the terminal device 15 may be implemented by software, firmware, or a combination of software and firmware.

In a case where the terminal device 15 is implemented by software, firmware, or the like, an information processing program for causing a computer to execute a processing procedure performed in each of the apparatus registration unit 21, the apparatus information acquiring unit 22, the identification information acquiring unit 23, the display data generating unit 24, the display processing unit 82, the communication establishment unit 26, the control unit 27, the combination information acquiring unit 81, and the apparatus cooperation unit 83 is stored in the memory 41 illustrated in FIG. 4. Then, the processor 42 illustrated in FIG. 4 executes the information processing program stored in the memory 41.

FIG. 16 illustrates an example in which each of the constituent elements of the terminal device 15 is implemented by dedicated hardware, and FIG. 4 illustrates an example in which the terminal device 15 is implemented by software, firmware, or the like. However, this is merely an example, and some of the constituent elements of the terminal device 15 may be implemented by dedicated hardware, and the remaining constituent elements may be implemented by software, firmware, or the like.

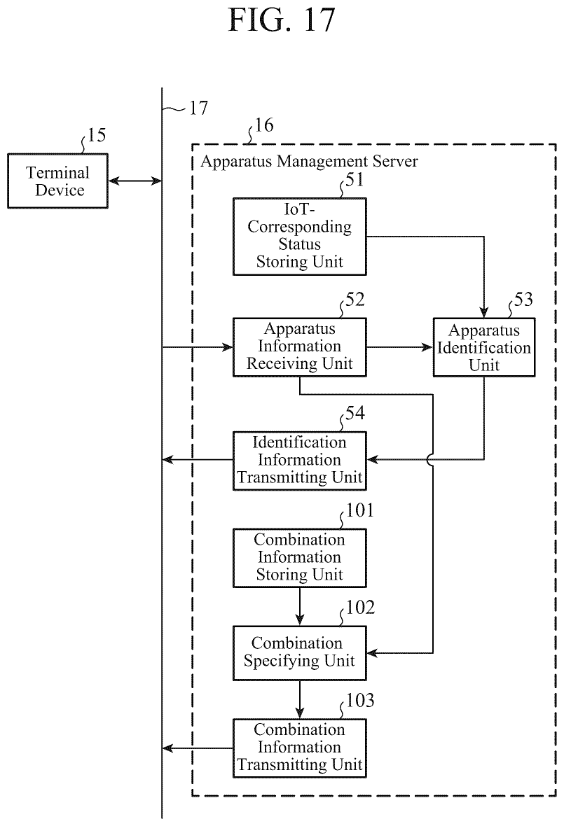

FIG. 17 is a configuration diagram illustrating the apparatus management server 16 according to the second embodiment. In FIG. 17, the same reference numerals as in FIG. 5 indicate the same or corresponding parts, and therefore description thereof is omitted.

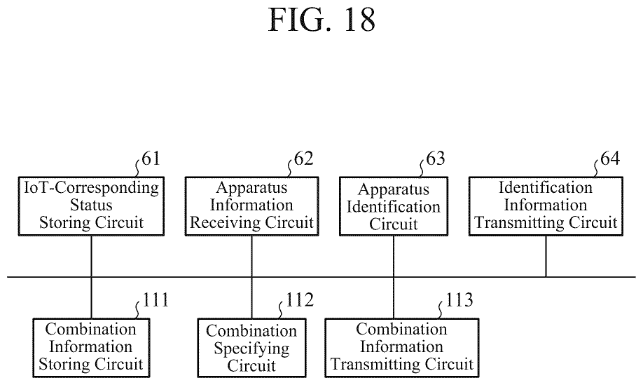

FIG. 18 is a hardware configuration diagram illustrating hardware of the apparatus management server 16 according to the second embodiment. In FIG. 18, the same reference numerals as in FIG. 6 indicate the same or corresponding parts, and therefore description thereof is omitted.

A combination information storing unit 101 is implemented by, for example, a combination information storing circuit 111 illustrated in FIG. 18.

The combination information storing unit 101 stores a combination of apparatuses capable of cooperating with each other in control.

A combination specifying unit 102 is implemented by, for example, a combination specifying circuit 112 illustrated in FIG. 18.

The combination specifying unit 102 acquires, from the apparatus information receiving unit 52, apparatus information indicating each of two or more apparatuses 11-n for which communication with the terminal device 15 is established.

The combination specifying unit 102 specifies a combination of apparatuses 11-n capable of cooperating with each other in control among two or more apparatuses 11-n on the basis of the combination stored by the combination information storing unit 101 and apparatus information of each of the apparatuses.

The combination specifying unit 102 outputs combination information indicating the specified combination to a combination information transmitting unit 103.

The combination information transmitting unit 103 is implemented by, for example, a combination information transmitting circuit 113 illustrated in FIG. 18.

The combination information transmitting unit 103 transmits the combination information indicating the combination specified by the combination specifying unit 102 to the terminal device 15 via the network 17.

In FIG. 17, it is assumed that each of the IoT-corresponding status storing unit 51, the apparatus information receiving unit 52, the apparatus identification unit 53, the identification information transmitting unit 54, the combination information storing unit 101, the combination specifying unit 102, and the combination information transmitting unit 103, which are constituent elements of the apparatus management server 16, is implemented by dedicated hardware as illustrated in FIG. 18. That is, it is assumed that the apparatus management server 16 is implemented by the IoT-corresponding status storing circuit 61, the apparatus information receiving circuit 62, the apparatus identification circuit 63, the identification information transmitting circuit 64, the combination information storing circuit 111, the combination specifying circuit 112, and the combination information transmitting circuit 113.

Here, to each of the IoT-corresponding status storing circuit 61 and the combination information storing circuit 111, for example, a nonvolatile or volatile semiconductor memory such as RAM, ROM, flash memory, EPROM, or EEPROM, a magnetic disk, a flexible disk, an optical disk, a compact disk, a mini disk, or DVD corresponds.

To each of the apparatus information receiving circuit 62, the apparatus identification circuit 63, the identification information transmitting circuit 64, the combination specifying circuit 112, and the combination information transmitting circuit 113, for example, a single circuit, a composite circuit, a programmed processor, a parallel programmed processor, an ASIC, a FPGA, or a combination thereof corresponds.

The constituent elements of the apparatus management server 16 are not limited to those implemented by dedicated hardware, and the apparatus management server 16 may be implemented by software, firmware, or a combination of software and firmware.

In a case where the apparatus management server 16 is implemented by software, firmware, or the like, the IoT-corresponding status storing unit 51 and the combination information storing unit 101 are constituted on the memory 71 illustrated in FIG. 7. A program for causing the computer to execute a processing procedure performed in each of the apparatus information receiving unit 52, the apparatus identification unit 53, the identification information transmitting unit 54, the combination specifying unit 102, and the combination information transmitting unit 103 is stored in the memory 71. The processor 72 illustrated in FIG. 7 executes the program stored in the memory 71.

FIG. 18 illustrates an example in which each of the constituent elements of the apparatus management server 16 is implemented by dedicated hardware, and FIG. 7 illustrates an example in which the apparatus management server 16 is implemented by software, firmware, or the like. However, this is merely an example, and some of the constituent elements of the apparatus management server 16 may be implemented by dedicated hardware, and the remaining constituent elements may be implemented by software, firmware, or the like.

Next, an operation of the information processing system 1 according to the second embodiment will be described.

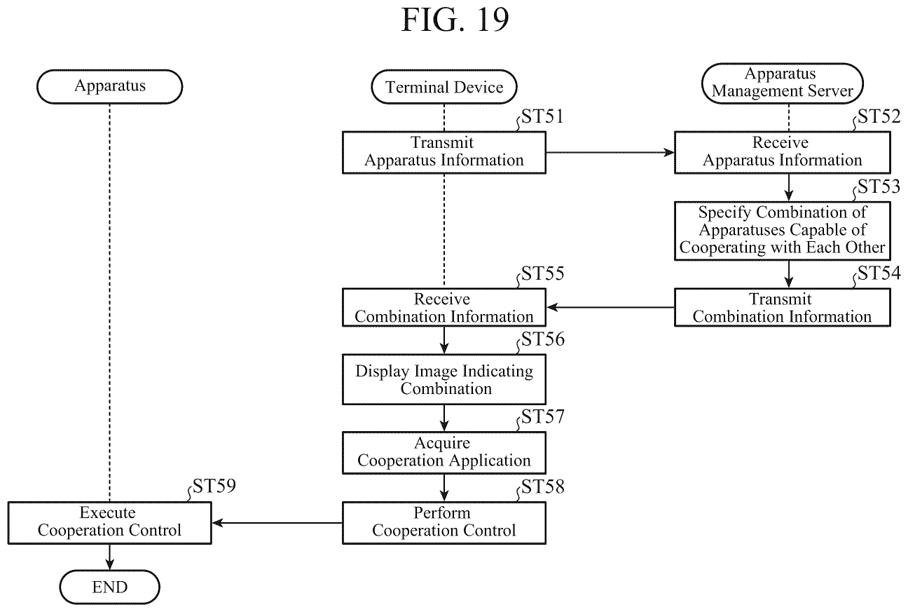

FIG. 19 is a time chart illustrating main parts of processing procedures performed in the apparatus 11-n, the terminal device 15, and the apparatus management server 16. Here, a difference from the information processing system 1 according to the first embodiment will be described.

When there are two or more apparatuses 11-n whose communication with the terminal device 15 is established by the communication establishment unit 26, the combination information acquiring unit 81 of the terminal device 15 transmits apparatus information indicating each of the apparatuses 11-n to the apparatus information receiving unit 52 of the apparatus management server 16 via the network 17 (step ST51 in FIG. 19).

Here, for convenience of description, it is assumed that, among the apparatuses 11-n registered in a “bought item list”, the apparatuses 11-n whose communication with the terminal device 15 is established are an air conditioner whose apparatus information is “ABC-0001”, an electric fan whose apparatus information is “GP-1234”, and a television whose apparatus information is “TV-567”. In this case, each of “ABC-0001”, “GP-1234”, and “TV-567” is transmitted from the combination information acquiring unit 81 to the apparatus information receiving unit 52 of the apparatus management server 16 via the network 17.

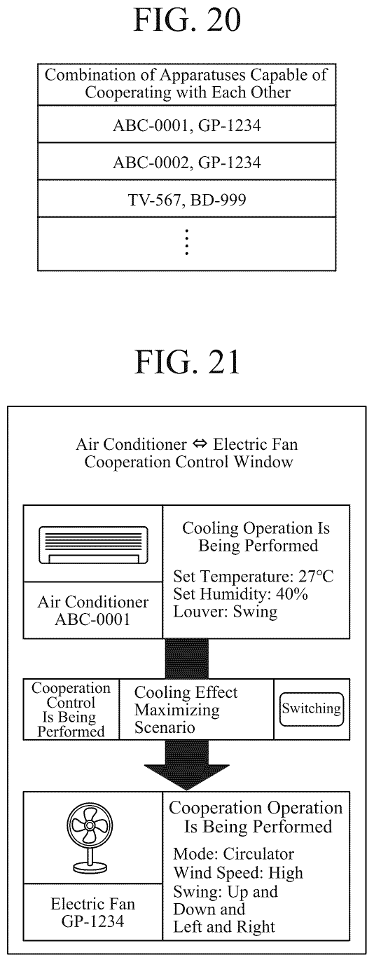

The combination information storing unit 101 of the apparatus management server 16 stores, for example, a combination of apparatuses capable of cooperating with each other in control as illustrated in FIG. 20.

FIG. 20 is an explanatory diagram illustrating an example of the combination of apparatuses capable of cooperating with each other in control.

In the example of FIG. 20, as the combination of apparatuses capable of cooperating with each other in control, a combination of an air conditioner whose apparatus information is “ABC-0001” and an electric fan whose apparatus information is “GP-1234” and the like are stored.

The apparatus information receiving unit 52 of the apparatus management server 16 receives the apparatus information indicating each of the apparatuses 11-n from the combination information acquiring unit 81 of the terminal device 15 via the network 17 (step ST52 in FIG. 19).

Here, the apparatus information receiving unit 52 receives “ABC-0001”, “GP-1234”, and “TV-567”.

The apparatus information receiving unit 52 outputs the apparatus information indicating each of the apparatuses 11-n to the combination specifying unit 102.

The combination specifying unit 102 refers to the combination stored by the combination information storing unit 101, and specifies a combination of apparatuses 11-n capable of cooperating with each other in control among the two or more apparatuses 11-n indicated by the received apparatus information (step ST53 in FIG. 19).

The combination information storing unit 101 stores a combination of an air conditioner of “ABC-0001” and an electric fan of “GP-1234”. Therefore, among the air conditioner of “ABC-0001”, the electric fan of “GP-1234”, and the television of “TV-567”, the combination of the air conditioner of “ABC-0001” and the electric fan of “GP-1234” is specified by the combination information transmitting unit 103 as the combination of apparatuses 11-n capable of cooperating with each other in control.

The combination specifying unit 102 outputs combination information indicating the specified combination to the combination information transmitting unit 103.

The combination information transmitting unit 103 transmits the combination information to the combination information acquiring unit 81 of the terminal device 15 via the network 17 (step ST54 in FIG. 19).

The combination information acquiring unit 81 of the terminal device 15 receives the combination information from the combination information transmitting unit 103 of the apparatus management server 16 via the network 17 (step ST55 in FIG. 19).

The combination information acquiring unit 81 outputs the combination information to each of the display processing unit 82 and the apparatus cooperation unit 83.

The display processing unit 82 of the terminal device 15 acquires the combination information from the combination information acquiring unit 81.

The display processing unit 82 displays an image indicating the combination of the apparatuses 11-n indicated by the combination information on the display of the display output device 13 (step ST56 in FIG. 19).

Here, an image indicating the combination of the air conditioner of “ABC-0001” and the electric fan of “GP-1234” is displayed on the display.

The apparatus cooperation unit 83 of the terminal device 15 acquires the combination information from the combination information acquiring unit 81.

The apparatus cooperation unit 83 recognizes a combination of apparatuses 11-n capable of cooperating with each other in control among the two or more apparatuses 11-n on the basis of the combination information.

Here, as the combination of apparatuses 11-n capable of cooperating with each other in control, the combination of the air conditioner of “ABC-0001” and the electric fan of “GP-1234” is recognized by the apparatus cooperation unit 83.

The apparatus cooperation unit 83 acquires a cooperation application for performing cooperation control between the apparatuses 11-n capable of cooperating with each other in control (step ST57 in FIG. 19).

Here, the apparatus cooperation unit 83 acquires a cooperation application for performing cooperation control between the air conditioner of “ABC-0001” and the electric fan of “GP-1234”. The cooperation application may be acquired by the apparatus cooperation unit 83, for example, when a request for acquiring the cooperation application is output from the operation input device 12 by a user operating the operation input device 12. In FIG. 15, a connection line between the operation input device 12 and the apparatus cooperation unit 83 is omitted. In addition, the apparatus cooperation unit 83 may voluntarily acquire the cooperation application.

The cooperation application can be acquired from, for example, a server of a manufacturer of the air conditioner of “ABC-0001” or a server of a third party other than the manufacturer, or a server of a manufacturer of the electric fan of “GP-1234” or a server of a third party other than the manufacturer. When the storage device 14 stores the cooperation application in advance, the apparatus cooperation unit 83 may acquire the cooperation application from the storage device 14.

The apparatus cooperation unit 83 performs cooperation control between the apparatuses 11-n using the acquired cooperation application (step ST58 in FIG. 19).

The cooperation control between the apparatuses 11-n is performed (step ST59 in FIG. 19).

Similarly to the control application, the cooperation application may be a mini-application.

Note that the cooperation control may be executed by the apparatus cooperation unit 83, but the apparatus cooperation unit 83 may supply the cooperation application to each of the apparatuses 11-n for which the cooperation control is performed, and each of the apparatuses 11-n may execute the cooperation application.

The display processing unit 82 of the terminal device 15 acquires the combination information from the combination information acquiring unit 81.

The display processing unit 82 recognizes the apparatuses 11-n for which the cooperation control is performed by the apparatus cooperation unit 83 on the basis of the combination information.

As illustrated in FIG. 21, the display processing unit 82 displays an execution status of the cooperation control performed by the apparatus cooperation unit 83 on the display of the display output device 13.

FIG. 21 is an explanatory diagram illustrating an example of the execution status of the cooperation control performed by the apparatus cooperation unit 83.

In the example of FIG. 21, while the air conditioner of “ABC-0001” is performing a cooling operation at a set temperature of 27° C. and a set humidity of 40% according to a cooperation control program called “cooling effect maximizing scenario”, the electric fan of “GP-1234” is performing a cooperation operation as a circulator.

The terminal device 15 illustrated in FIG. 15 includes both the control unit 27 and the apparatus cooperation unit 83. Therefore, while the apparatus cooperation unit 83 is performing cooperation control between two or more apparatuses 11-n, the control unit 27 may accept control of any of the apparatuses 11-n.

While the apparatus cooperation unit 83 is performing cooperation control, for example, between the air conditioner of “ABC-0001” and the electric fan of “GP-1234”, the control unit 27 may accept, for example, control of the air conditioner of “ABC-0001”.

As described above, in a case where the cooperation control and the control performed by the control unit 27 overlap with each other, the control unit 27 compares priority of the cooperation control with priority of the control accepted by the control unit 27 itself. The priority of the cooperation control and the priority of the control accepted by the control unit 27 may be stored in an internal memory of the control unit 27 or may be supplied from the outside of the terminal device 15.

When the priority of the cooperation control performed by the apparatus cooperation unit 83 is higher than the priority of the control accepted by the control unit 27, the control unit 27 outputs, to the apparatus cooperation unit 83, an instruction to prioritize the cooperation control performed by the apparatus cooperation unit 83. In addition, the control unit 27 outputs, to the display processing unit 82, a notification indicating that execution of the cooperation control is prioritized.

When receiving the instruction to prioritize the cooperation control from the control unit 27, the apparatus cooperation unit 83 performs the cooperation control. At this time, the control unit 27 cancels the control accepted by the control unit 27 itself or executes the control accepted by the control unit 27 itself after the execution of the cooperation control is completed.

When receiving the notification that the execution of the cooperation control is prioritized, the display processing unit 82 generates display data of an image indicating that the execution of the cooperation control is prioritized.

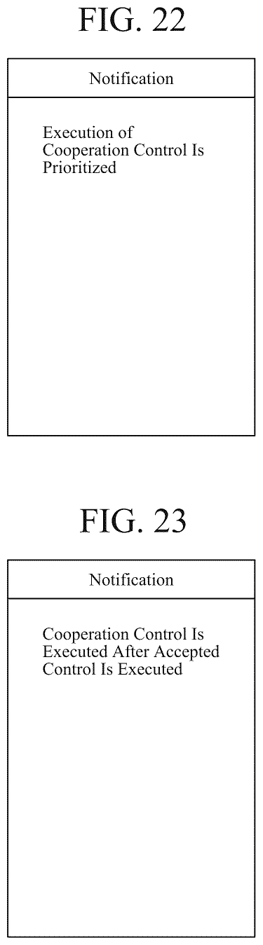

The display processing unit 82 displays the image indicating that the execution of the cooperation control is prioritized on the display of the display output device 13, as illustrated in FIG. 22, by causing the display output device 13 to output the display data.

FIG. 22 is an explanatory diagram illustrating an example of the image indicating that the execution of the cooperation control is prioritized.

When the priority of the cooperation control performed by the apparatus cooperation unit 83 is equal to or lower than the priority of the control accepted by the control unit 27, the control unit 27 outputs, to the apparatus cooperation unit 83, an instruction to prioritize the control accepted by the control unit 27 itself. In addition, the control unit 27 outputs, to the display processing unit 82, a notification indicating that execution of the control accepted by the control unit 27 itself is prioritized.

When receiving an instruction to prioritize the control accepted by the control unit 27 from the control unit 27, the apparatus cooperation unit 83 waits until the execution of the control accepted by the control unit 27 is completed.

At this time, the control unit 27 executes the control accepted by the control unit 27 itself.

When the execution of the control accepted by the control unit 27 is completed, the apparatus cooperation unit 83 executes the cooperation control.

When receiving the notification indicating that execution of the control accepted by the control unit 27 is prioritized from the control unit 27, the display processing unit 82 generates display data of an image indicating that the cooperation control is executed after the control accepted by the control unit 27 is executed.

The display processing unit 82 displays the image indicating that the cooperation control is executed after the control accepted by the control unit 27 is executed on the display of the display output device 13, as illustrated in FIG. 23, by causing the display output device 13 to output the display data.

FIG. 23 is an explanatory diagram illustrating an example of the image illustrating that the cooperation control is executed after the control accepted by the control unit 27 is executed.

The terminal device 15 illustrated in FIG. 15 indicates that a combination of apparatuses 11-n capable of cooperating with each other in control includes a combination of apparatuses 11-n whose communication with the terminal device 15 is established among two or more apparatuses 11-n. That is, the apparatuses that can be used for the combination include an IoT apparatus or a quasi-IoT apparatus. However, this is merely an example, and a non-IoT apparatus may be included in the combination of the apparatuses 11-n capable of cooperating with each other in control, by a user operation.

For example, in a case where an air conditioner that is an IoT apparatus and an electric fan that is a non-IoT apparatus are included in the combination, the display data generating unit 24 generates display data indicating a message such as “when the fan is manually activated, a cooling effect is maximized” when the air conditioner reaches a specific condition. Then, the display processing unit 82 may display the message on the display according to the display data.

### Third Embodiment

In a third embodiment, a terminal device 15 will be described in which a display processing unit 82 displays an arrangement diagram indicating an arrangement of apparatuses 11-n owned by a user on a display, and switches display of the apparatuses included in the arrangement diagram according to display data generated by a display data generating unit 24.

The configuration of the terminal device 15 according to the third embodiment is similar to the configuration of the terminal device 15 according to the second embodiment, and a configuration diagram illustrating the terminal device 15 according to the third embodiment is illustrated in FIG. 15.

Next, an operation of the terminal device 15 according to the third embodiment will be described.

In the terminal device 15 according to the third embodiment, it is assumed that arrangement data of an arrangement diagram indicating arrangement of apparatuses 11-n owned by a user is stored in an internal memory of the display processing unit 82. However, this is merely an example, and for example, the arrangement data of the arrangement diagram may be supplied from the outside of the terminal device 15 by the user operating an operation input device 12.

The display processing unit 82 displays the arrangement diagram indicating arrangement of apparatuses owned by a user on a display of a display output device 13 on the basis of the arrangement data.

In addition, the display processing unit 82 switches display of apparatuses 11-n included in the arrangement diagram according to the display data generated by the display data generating unit 24.

When an apparatus 11-n included in the arrangement diagram is an IoT apparatus, the apparatus 11-n is displayed in, for example, blue. When an apparatus 11-n is a quasi-IoT apparatus, the apparatus 11-n is displayed in, for example, yellow. When an apparatus 11-n is a non-IoT apparatus, the apparatus 11-n is displayed in, for example, red.

In addition, whether or not control of an apparatus 11-n included in the arrangement diagram is being executed is displayed.

The control unit 27 has a function of accepting control of an apparatus 11-n included in the arrangement diagram when the apparatus 11-n is tapped by a user in a case where the apparatus 11-n is an apparatus whose communication with the terminal device 15 is established.

When an apparatus 11-n included in the arrangement diagram is tapped by the user, the control unit 27 executes control of the apparatus 11-n.

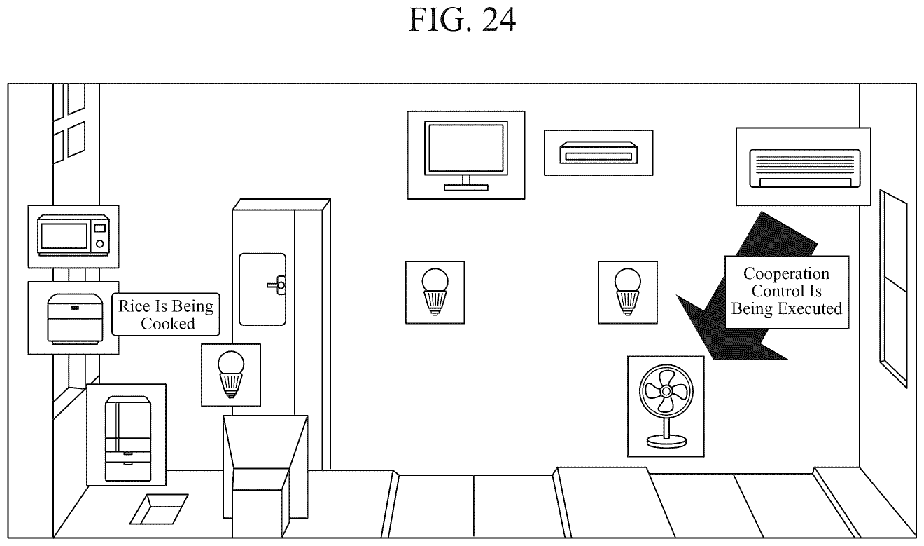

In a case where there is a plurality of apparatuses 11-n for which cooperation control is performed by the apparatus cooperation unit 83 among apparatuses 11-n included in the arrangement diagram, the display processing unit 82 displays an execution status of the cooperation control in the plurality of apparatuses 11-n on the arrangement diagram as illustrated in FIG. 24.

FIG. 24 is an explanatory diagram illustrating a display example of the execution status of the cooperation control.

In the example of FIG. 24, cooperation control between an air conditioner of “ABC-0001” and an electric fan of “GP-1234” is performed, and the cooperation control is indicated by an animation of an arrow.

The example of FIG. 24 indicates that a rice cooker, which is an apparatus 11-n, is cooking rice.

Note that, in the present disclosure, the embodiments can be freely combined to each other, any constituent element in each of the embodiments can be modified, or any constituent element in each of the embodiments can be omitted.

### INDUSTRIAL APPLICABILITY

The present disclosure is suitable for a terminal device, an apparatus management server, an information processing system, an information processing method, and a non-transitory computer readable medium.

### REFERENCE SIGNS LIST

1: information processing system, 11-1 to 11-N: apparatus, 12: operation input device, 13: display output device, 14: storage device, 15: terminal device, 16: apparatus management server, 17: network, 21: apparatus registration unit, 22: apparatus information acquiring unit, 23: identification information acquiring unit, 24: display data generating unit, 25: display processing unit, 26: communication establishment unit, 27: control unit, 31: apparatus registration circuit, 32: apparatus information acquiring circuit, 33: identification information acquiring circuit, 34: display data generating circuit, 35: display processing circuit, 36: communication establishment circuit, 37: control circuit 41: memory, 42: processor, 51: IoT-corresponding status storing unit, 52: apparatus information receiving unit, 53: apparatus identification unit, 54: identification information transmitting unit, 61: IoT-corresponding status storing circuit, 62: apparatus information receiving circuit, 63: apparatus identification circuit, 64: identification information transmitting circuit, 71: memory, 72: processor, 81: combination information acquiring unit, 82: display processing unit, 83: apparatus cooperation unit, 91: combination information acquiring circuit, 92: display processing circuit, 93: apparatus cooperation circuit, 101: combination information storing unit, 102: combination specifying unit, 103: combination information transmitting unit, 111: combination information storing circuit, 112: combination specifying circuit, 113: combination information transmitting circuit

1. A terminal device comprising:
processing circuitry configured to
acquire apparatus information indicating a registered apparatus;
acquire identification information indicating whether the apparatus is an IoT apparatus or a non-IoT apparatus from an apparatus management server by transmitting the acquired apparatus information to the apparatus management server; and
generate display data indicating whether the apparatus is the IoT apparatus or the non-IoT apparatus on a basis of the acquired identification information, and to output the display data.

2. The terminal device according to claim 1, wherein
the processing circuitry is further configured to
acquire, from the apparatus management server, identification information indicating whether the apparatus is the IoT apparatus, a quasi-IoT apparatus that corresponds to IoT if a certain condition is satisfied, or the non-IoT apparatus, and
generate display data indicating whether the apparatus is the IoT apparatus, the quasi-IoT apparatus, or the non-IoT apparatus on a basis of the acquired identification information.

3. The terminal device according to claim 2,
wherein the processing circuitry is further configured to display an image indicating whether the apparatus is the IoT apparatus, the quasi-IoT apparatus, or the non-IoT apparatus on a display in accordance with the generated display data.

4. The terminal device according to claim 3,
wherein the processing circuitry is further configured to establish communication between the apparatus and the terminal device when the apparatus is the IoT apparatus or the quasi-IoT apparatus satisfying the condition.

5. The terminal device according to claim 4,
wherein the processing circuitry is further configured to accept control of an apparatus whose communication with the terminal device is established and control the apparatus.

6. The terminal device according to claim 5, wherein the processing circuitry acquires a control application of the apparatus whose communication with the terminal device is established and executes the control application when accepting the control of the apparatus.

7. The terminal device according to claim 6, wherein the acquired control application is a common control application capable of controlling a plurality of apparatuses belonging to an apparatus category to which the apparatus whose communication with the terminal device is established belongs.

8. The terminal device according to claim 4,
wherein the processing circuitry is further configured to
acquire, from the apparatus management server, combination information indicating a combination of apparatuses capable of cooperating with each other in control among two or more apparatuses, when there are the two or more apparatuses whose communication with the terminal device is established, by transmitting apparatus information indicating each of the apparatuses to the apparatus management server; and
perform cooperation control between apparatuses according to the combination indicated by the acquired combination information.

9. The terminal device according to claim 8, wherein the processing circuitry acquires a cooperation application for performing the cooperation control between apparatuses according to the combination indicated by the acquired combination information and executes the cooperation application.

10. The terminal device according to claim 8, wherein the processing circuitry displays an execution status of the cooperation control on the display.

11. The terminal device according to claim 8, wherein
in a case where an apparatus for which the cooperation control is performed and an apparatus for which control has been accepted overlap with each other,
when a priority of the cooperation control is higher than a priority of the accepted control, the cooperation control performed by the apparatus cooperation unit is prioritized, and when the priority of the cooperation control is equal to or lower than the priority of the accepted control, the accepted control is prioritized.

12. The terminal device according to claim 11, wherein when the cooperation control is prioritized, the processing circuitry displays that execution of the cooperation control is prioritized on the display, and when the accepted control is prioritized, the processing circuitry displays that the cooperation control is executed after the accepted control is executed on the display.

13. The terminal device according to claim 3, wherein the processing circuitry displays an arrangement diagram indicating an arrangement of apparatuses owned by the user on the display, and switches display of the apparatuses included in the arrangement diagram in accordance with the generated display data.

14. The terminal device according to claim 13,
wherein the processing circuitry is further configured to
establish communication between the apparatus and the terminal device when the apparatus is the IoT apparatus or the quasi-IoT apparatus satisfying the certain condition; and
accept control of an apparatus whose communication with the terminal device is established, and to control the apparatus, wherein
when an apparatus included in the arrangement diagram is tapped, the processing circuitry accepts control of the apparatus.

15. The terminal device according to claim 14,
wherein the processing circuitry is further configured to
acquire, from the apparatus management server, combination information indicating a combination of apparatuses capable of cooperating with each other in control among the two or more apparatuses, when there are the two or more apparatuses whose communication with the terminal device is established, by transmitting apparatus information indicating each of the apparatuses to the apparatus management server; and
perform cooperation control between apparatuses according to the combination indicated by the acquired combination information, wherein
in a case where there is a plurality of apparatuses for which cooperation control is performed among the apparatuses included in the arrangement diagram, the processing circuitry displays an execution status of the cooperation control in the plurality of apparatuses on the arrangement diagram.

16. An apparatus management server comprising:
processing circuitry configured to receive apparatus information indicating a registered apparatus from a terminal device;
identify whether the apparatus is an IoT apparatus or a non-IoT apparatus on a basis of the received apparatus information, and output identification information indicating whether the apparatus is the IoT apparatus or the non-IoT apparatus; and
transmit, to the terminal device, the identification information having been output.

17. The apparatus management server according to claim 16, wherein the processing circuitry identifies whether the apparatus is the IoT apparatus, a quasi-IoT apparatus that corresponds to IoT if a certain condition is satisfied, or the non-IoT apparatus on a basis of the received apparatus information and outputs the identification information indicating whether the apparatus is the IoT apparatus, the quasi-IoT apparatus, or the non-IoT apparatus.

18. The apparatus management server according to claim 17,
wherein the processing circuitry is further configured to
specify a combination of apparatuses capable of cooperating with each other in control among two or more apparatuses on a basis of the received apparatus information when apparatus information in each of the two or more apparatuses is received from the terminal device; and
transmit combination information indicating the specified combination to the terminal device.

19. An information processing system comprising:
first processing circuitry configured to
acquire apparatus information indicating a registered apparatus;
an apparatus management server to receive the apparatus information indicating the apparatus, to identify whether the apparatus is an IoT apparatus or a non-IoT apparatus on a basis of the apparatus information, and to transmit identification information indicating whether the apparatus is the IoT apparatus or the non-IoT apparatus;
second processing circuitry configured to
acquire the identification information from the apparatus management server by transmitting the acquired apparatus information to the apparatus management server; and
generate display data indicating whether the apparatus is the IoT apparatus or the non-IoT apparatus on a basis of the acquired identification information, and output the display data.

20. An information processing method comprising:
acquiring apparatus information indicating a registered apparatus;
acquiring identification information indicating whether the apparatus is an IoT apparatus or a non-IoT apparatus from an apparatus management server by transmitting the acquired apparatus information to the apparatus management server; and
generating display data indicating whether the apparatus is the IoT apparatus or the non-IoT apparatus on a basis of the acquired identification information and outputting the display data.

21. A non-transitory computer readable medium with an executable program stored thereon, wherein the program instructs a computer to perform
acquiring apparatus information indicating a registered apparatus;
acquiring identification information indicating whether the apparatus is an IoT apparatus or a non-IoT apparatus from an apparatus management server by transmitting the acquired apparatus information to the apparatus management server; and
generating display data indicating whether the apparatus is the IoT apparatus or the non-IoT apparatus on a basis of the acquired identification information and outputting the display data.
